(19) United States
(12) Patent Application Publication
(10) Pub. No.: US 2006/0088041 A1
(43) Pub. Date: Apr. 27, 2006

(54) System, device, and method to automatically disable the camera function of a wireless communication device

(76) Inventor: Esteban A. Rockett, Lansdale, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 10/970,481

(22) Filed: Oct. 21, 2004

(51) Int. Cl. H04L 12/56; H04L 12/28

(52) U.S. Cl. 370/401

(57) ABSTRACT

A system, device, and method for discretely automatically disabling a camera feature in a wireless communication client device is disclosed. The present invention provides for a wireless gateway, or similar device, on a premise which communicates with a wireless client device and disables the camera feature in the client device utilizing the wireless network.

### FIELD OF THE INVENTION

The present invention relates to wireless communication devices. More specifically, the present invention relates to the wireless communications devices with built in cameras.

### BACKGROUND OF THE INVENTION

With the rapid proliferation of wireless communication devices (such as the device formerly known as a cellular telephone, PDAs, etc.), manufacturers of such devices are incorporating more features, beyond conventional communications, into these devices. Such features include internet access/web browsing, and digital cameras. Of these features the camera feature has become immensely popularly, and has resulted a great demand for wireless communication devices with cameras (“Camconds”), such as the well known camera phones.

While this added functionality is welcomed by many, the Camconds cause a great security concern for many company in terms of protecting their confidential information. Many companies are concerned that visitors, as well as dishonest employees, will attempt to use a Camcond to photograph confidential information while on the companies premises/campus. Without searching every visitor or employee for such Camconds upon enters onto/into a facility where confidential information is present, preventing such unlawful and unethical conduct is virtually impossible.

Similarly, many homeowners may wish to not have their privacy invaded by a visitor photographing their home, or the contents thereof, using a Camcond without the home owners consent.

Lastly, many retail and performance based industries also are concerned about visitors inappropriately photographing their facility(ies), performances, or products. Examples include, theatre shows (e.g., Broadway) where producers do not want any part of the show photographed, or even clothing designers, where unlawful knock-off artists often enter the retail store of a designer and photograph the merchandise to later creates unlawful knock-offs to sell on the black market.

What is needed is a discrete way to automatically prevent use of the camera in a Camcond without interaction with its user.

### SUMMARY OF INVENTION

An object of the present invention is to provide a discrete way to automatically prevent use of a camera in a wireless communication device without interaction with its user.

In order to achieve this objective, as well as others which will become apparent in the disclosure below, the present invention provides for a system, device and method which utilizes the wireless network (e.g., 802.11 (“WiFi”)) capabilities of a Camcond to disable the camera feature.

In accordance with an exemplary embodiment of the present invention, a wireless gateway, or similar device, on a premise attempts to communicate with wireless clients in its radio frequency (“RF”) range. If the wireless gateway finds a wireless client, the wireless gateway queries the wireless client for the camera feature. If the camera feature is present the wireless client, the wireless gateway sends a signal to the wireless client to disable the camera. Further, a premise can have a plurality of wireless gateway devices covering the entire premises and/or wireless gateway devices can be physically located at the entry points to premises (where camera disabling is desired).

Thus, the present invention provides a discrete way to automatically prevent use of a camera in a wireless communication device without interaction with its user.

### BRIEF DESCRIPTION OF THE DRAWINGS

For a complete understanding of the present invention and the advantages thereof, reference is now made to the following description taken in conjunction with the accompanying drawings in which like reference numbers indicate like features, components and method steps, and wherein:

FIG. 1 is an illustration of a wireless communication client device with built in camera, which can be disabled with wireless communications in accordance with an exemplary embodiment of the present invention;

FIG. 2 is an illustration of a system for discretely automatically disabling the camera in the wireless device of FIG. 1, without interaction with its user, in accordance with an exemplary embodiment of the present invention; and

FIG. 3 is a flow diagram showing the basic process flow for discretely automatically disabling the camera in the wireless device of FIG. 1, without interaction with its user, in accordance with an exemplary embodiment of the present invention.

### DESCRIPTION OF A PRESENTLY PREFERRED EMBODIMENT

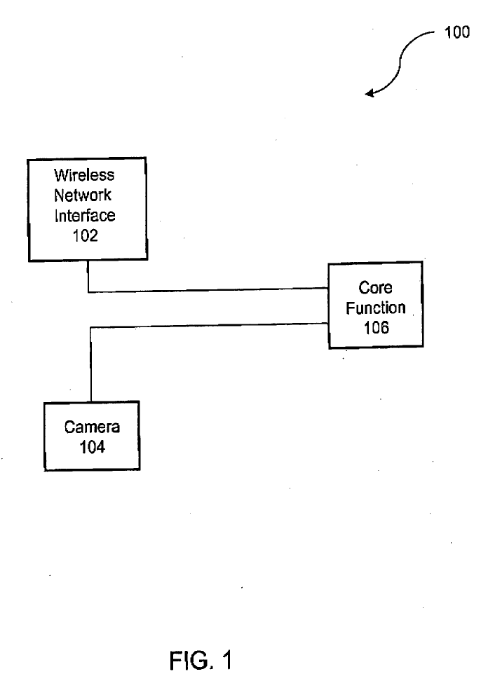

Referring to FIG. 1, device 100 is shown. Device 100 is a wireless communications device which includes a wireless network interface 102, camera 104, and core function unit 106. (Device 100 hereinafter will be referred to as “Camcond 100”). Camera 104 is capable of being enabled or disabled from a signal received via wireless network interface 102. Wireless network interface 102 is capable of providing interconnection to a wireless network, preferably, 802.11 in this exemplary embodiment of the present invention, for camera 102. Core function unit 106 contains the primary core components of the Camcond 100. For example, if Camcond 100 is primarily a wireless telephone, such components would reside in core function unit 106. Core functions could also include electronic mail client, pager, text messenger, personal data assistance (PDA), etc.

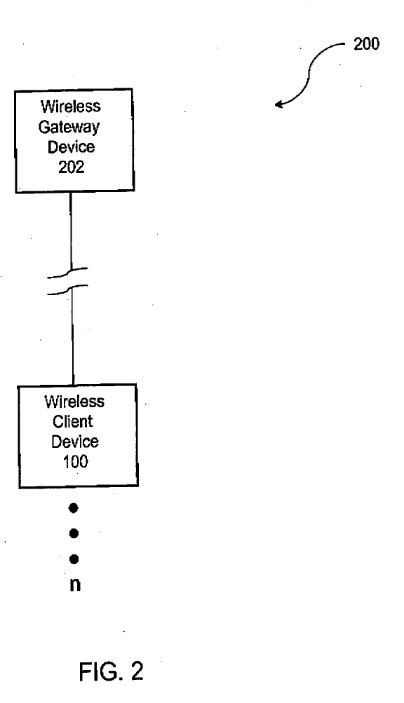

Referring to FIG. 2, a system 200 is shown. System 200 is a system for discretely automatically disabling the camera in a Camcond 100, without interaction with its user, in accordance with an exemplary embodiment of the present invention. System 100 include a wireless gateway device 202 and one or more wireless client devices (Camconds) 100.

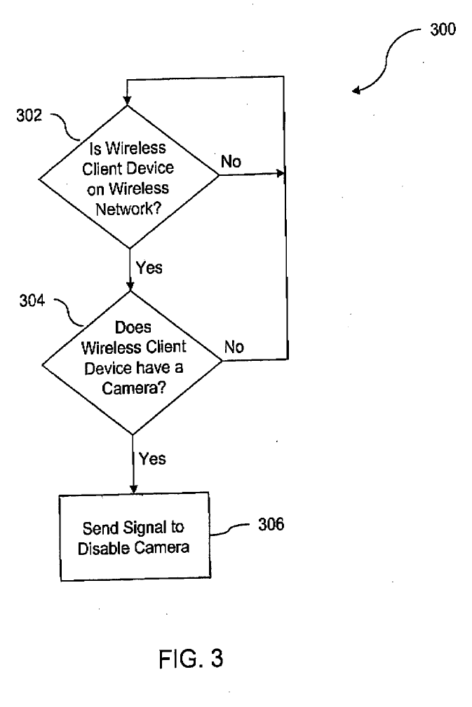

Referring to FIG. 3, in operation, the wireless gateway device 202 continuously searches for Camconds 100, in step 302. When wireless gateway device 202 finds a Camcond 100, the wireless gateway device established communication with the Camcond 100 and queries the Camcond 100 to determine if the Camcond 306 has a camera 104 therein, in step 304. If the Camcond 100 has a camera 104 therein as determined by step 304, the wireless gateway device 202 sends a signal to the Camcond 100 to disable the camera feature of camera 100, in step 308. Thus, the user will not be able to take pictures while on the premise of wireless gateway device 202. Towards this end multiple wireless gateway devices 202 may be used to populate a premises. If the premises is to large, or it is not cost effective to have multiple wireless gateway devices 202 to disable the camera 104 of Camconds 100 on the premises, wireless gateway devices 202 can alternatively be positioned only at entry points, where the disable signal, in step 308, would embody a fix pre-determined time the camera will be disabled, e.g., 1, 2, 3, 12 or 24 hours.

Although the invention has been described herein by reference to an exemplary embodiment thereof, it will be understood that such embodiment is susceptible of modification and variation without departing from the inventive concepts disclosed. For example, wireless protocols other than 802.11, such as Bluetooth, may be utilized for the instant invention. All such modifications and variations, therefore, are intended to be encompassed within the spirit and scope of the appended claims.

We claim:

1. A system for disabling a camera in a wireless communications device, said system comprising:
a wireless gateway, said wireless gateway providing wireless connectivity to wireless client devices in the radio frequency range of said wireless gateway; and
a wireless client device, said wireless client device capable of connecting to a wireless network of said wireless gateway, said wireless client device comprising a camera, wherein said camera is automatically disabled by said wireless gateway in response to said wireless client device being connected to said wireless network.

2. The system of claim 1 wherein said wireless network comprises the 802.11 protocol.

3. The system of claim 1 wherein said wireless client device further comprises a telephone.

4. The system of claim 1 wherein said wireless client device further comprises a personal data assistant.

5. The system of claim 1 wherein said wireless client device further comprises an electronic mail client.

6. The system of claim 1 wherein said wireless client device further comprises a text messenger.

7. The system of claim 1 wherein said wireless client device further comprises a pager.

8. A wireless communication device with a built in camera, said device comprising:
a camera; and
a wireless interface for communicatively interconnecting with a wireless network, said wireless interface couple to said camera, said camera selectively being disabled by a signal received from said wireless network.

9. The device of claim 3 wherein said wireless network comprises the 802.11 protocol.

10. The device of claim 3 wherein said signal is received from a wireless gateway, said gateway providing wireless connectivity to said device when said device is in a radio frequency range of said wireless gateway.

11. The device of claim 3 further comprising a telephone.

12. The device of claim 3 further comprising a personal data assistant.

13. The device of claim 3 further comprising an electronic mail client.

14. The device of claim 3 further comprising a text messenger,

15. The device of claim 3 further comprising a pager.

16. A method for disabling a camera in a wireless communications device, said method comprising:
determining a presence of a wireless client device on a wireless network;
determining a camera in said wireless client device; and
sending a signal to disable said camera in said wireless device if said wireless client is on said wireless network and has said camera therein.

17. The method of claim 16, wherein said wireless network utilizes 802.11.

18. The method of claim 16 further comprising maintaining said disabled state of said camera.

19. The method of claim 16 further comprising maintaining said disabled state of said camera of a fixed pre-defined period.

20. The method of claim 19, wherein said fixed pre-defined period is one of 1, 2, 3, 12 and 24 hours.
